(19) United States
(12) Patent Application Publication
(10) Pub. No.: US 2026/0361123 A1
(43) Pub. Date: Nov. 12, 2026

(54) POWER INTERCHANGE SYSTEM

(71) Applicant: HITACHI, LTD., Tokyo (JP)

(72) Inventors: Jun Tsunoda, Tokyo (JP); Toru Kouno, Tokyo (JP); Naoki Yoshida, Tokyo (JP); Eri Isozaki, Tokyo (JP); Keito Akizuki, Tokyo (JP)

(73) Assignee: HITACHI, LTD., Tokyo (JP)

(21) Appl. No.: 19/123,907

(22) PCT Filed: Nov. 8, 2023
(86) PCT No.: PCT/JP2023/040283

§ 371 Date: Apr. 24, 2025

(30) Foreign Application Priority Data
Nov. 11, 2022 (JP) 2022-180964

(51) Int. Cl. H02J 13/12

(52) U.S. Cl. CPC H02J 13/12

(57) ABSTRACT

A power interchange system according to the invention searches for a power transmission source site in a weather pattern in which power generation amount variation of a solar battery power generation system is small and transmits a surplus power amount at the power transmission source site to a power transmission source site in a weather pattern in which the power generation amount variation is large. The power interchange system includes at least one of a photovoltaic (PV) system and a storage battery system. The photovoltaic system and the storage battery system are connected to a power transmission network via a DCDC converter and a DCAC converter. A power control device transmits an operation command to a driving device for photo voltaic and a driving device for a storage battery (each of which is formed by the converter), thereby controlling operations of the photovoltaic and the storage battery.

### TECHNICAL FIELD

The present invention relates to a power interchange system that transmits a power amount between sites via a power transmission network.

### BACKGROUND ART

In recent years, awareness of a power demander for carbon neutrality has been increased, and a power generation system in which photo voltaic (PV) using natural energy and a storage battery are arranged side by side has been widely used. Such a power generation system is also used as a power interchange system in which a company or the like including a power generation facility can supply (transmit) power generated by the power generation system to another system via a power transmission network or the like of the power company or receive power supplied from another system.

When power interchange is performed from one or more sites, it is necessary to submit an interchange plan to an operation institution (for example, Organization for Cross-regional Coordination of Transmission Operators: OCCTO) before power transmission is started (for example, the previous day). Further, while the power interchange is performed, it is necessary to transmit power as planned in advance at predetermined time intervals (for example, 30 minutes). When actual transmitted power deviates from the advance plan (imbalance), a penalty is generally imposed.

The following PTL 1 has an object of “providing an energy management system capable of collectively performing charge and discharge management of home power storage units in an area including a plurality of houses each including a photo voltaic unit and a home power storage unit, and efficiently performing charge and discharge and power interchange”, and describes a technique that “an energy management system 1 includes: a data receiving unit 27 for receiving weather report data and receiving remaining stored power data of a home power storage unit 13; and a control unit 26 for controlling charge and discharge of the home power storage unit 13 based on information including the weather report data and the remaining stored power data. The control unit 26 divides houses 11 into groups based on levels of power generation capacity of first photo voltaic unit 12 of the houses 11 and levels of the remaining stored power data of the home power storage units 13 received by the data receiving unit 27 and determines the charge and discharge of the home power storage unit 13 or power interchange to the second area for each corresponding group” (see Abstract).

The following PTL 2 has an object of “providing a control device and control program for power interchange system, capable of functioning a storage battery as a power supply for backup for a long time by ensuring SOC of the storage battery when a power supply is shut down because of occurrence of a disaster”, and describes a technique that “a control device 1 includes: a power prediction unit 12 predicting consuming power of a load and generated power of a solar battery; a disaster occurrence prediction unit 11 predicting a disaster occurrence probability based on weather data; and an operation plan optimization unit 13 creating an operation plan for controlling charge and discharge of a storage battery based on a prediction result of the power prediction unit 12 and a prediction result of the disaster occurrence prediction unit 11” (see Abstract).

### CITATION LIST

### Patent Literature

PTL 1: JP2017-225301A
PTL 2: JP2017-108560A

### SUMMARY OF INVENTION

### Technical Problem

A case where a power generation system that generates power to be transmitted by power interchange is implemented by, for example, photo voltaic and a storage battery will be considered. An output power amount from photo voltaic varies depending on a solar radiation amount. There are various variation patterns in a case where the solar radiation amount greatly varies in one day or a case where the solar radiation amount is relatively stable depending on weather. Accordingly, various variation patterns are shown in a case where the output power amount from the photo voltaic also greatly varies or is relatively stable depending on the weather. For example, in order to transmit power according to the power amount (=interchange plan) planned to be interchanged in advance while the power interchange is being performed from one site on a day when the generated power amount (=interchange result) varies greatly, it is necessary to prevent the interchange plan to be smaller than a maximum power point, and to instruct the storage battery to perform a discharge operation to compensate the power amount for the shortage of the power amount.

At this time, in order not to reduce the power amount to be interchanged between sites as much as possible, it is necessary to minimize a suppression amount of the interchange plan. However, it is not always easy to accurately determine the suppression amount from the maximum power point when the variation of the interchange result is large. In particular, there has been a problem that in the case of power interchange from one site, when the suppression amount cannot be correctly set, the generated power amount is greatly discarded in order to avoid the imbalance penalty, or the number of times of discharge of the storage battery increases in order to compensate for the power shortage, which causes a stress on the storage battery.

The invention has been made in view of the above problems, and an object of the invention is to provide a technique capable of accurately determining a power amount to be interchanged between sites even when a power amount generated by a photo voltaic system greatly varies depending on weather.

### Solution to Problem

The power interchange system according to the invention searches for a power transmission source site in a weather pattern in which power generation amount variation of a solar battery power generation system is small, and transmits a surplus power amount at the power transmission source site to a power transmission source site in a weather pattern in which the power generation amount variation is large.

### Advantageous Effects of Invention

According to a power interchange system of the invention, it is possible to accurately determine a power amount to be interchanged between sites even when a power amount generated by a photo voltaic system greatly varies depending on weather. Problems, configurations, effects, or the like other than those described above will become apparent in the following description of embodiments.

### BRIEF DESCRIPTION OF DRAWINGS

FIG. 1 is a configuration example of a power interchange system 1 provided in a company that performs power interchange.

FIG. 2 is a schematic diagram showing a state in which the power interchange is performed between sites.

FIG. 3 shows an example of weather prediction data provided by a weather information provider.

FIG. 4 shows an example of determining each weather pattern based on a weather code in the weather prediction data of FIG. 3.

FIG. 5 is a flowchart showing a procedure in which the weather pattern is determined based on the weather code in the weather prediction data of FIG. 3.

FIG. 6A is a graph for comparing an interchange result and an interchange plan in a weather pattern A+.

FIG. 6B is a graph for comparing an interchange result and an interchange plan in a weather pattern A−.

FIG. 6C is a graph for comparing an interchange result and an interchange plan in a weather pattern B−.

FIG. 7 shows an example of data of rated generated power of photo voltaic for each site.

FIG. 8 is a flowchart showing a procedure in which a power control device 11 determines a combination of power interchange sites according to a weather pattern.

FIG. 9A is a diagram showing a power interchange method for compensating for a power shortage amount from a plurality of sites.

FIG. 9B is a diagram showing the power interchange method for compensating for the power shortage amount from the plurality of sites.

FIG. 10 is an example of a user interface provided by the power control device 11.

### DESCRIPTION OF EMBODIMENTS

### Embodiment 1

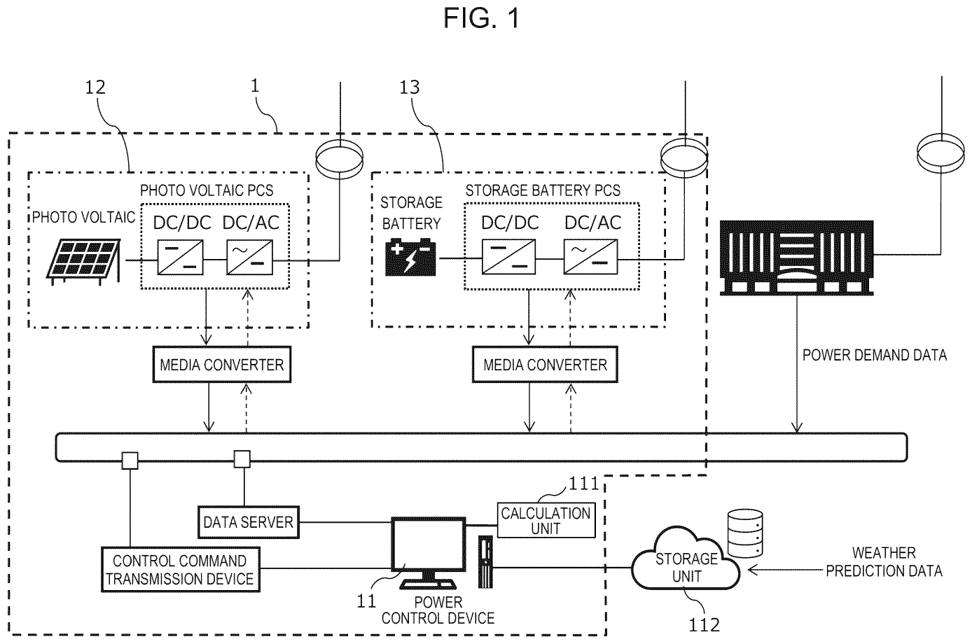

FIG. 1 is a configuration example of a power interchange system 1 provided in a company that performs power interchange. The power interchange system 1 includes at least one of a photo voltaic (PV) system 12 and a storage battery system 13. The photo voltaic system 12 and the storage battery system 13 are connected to a power transmission network via a DCDC converter and a DCAC converter. A power control device 11 transmits an operation command to a driving device for photo voltaic and a driving device for a storage battery (each of which is formed by the converter), thereby controlling operations of the photo voltaic and the storage battery. A plurality of photo voltaic systems 12 and storage battery systems 13 may be provided. The power control device 11 includes a calculation unit 111 and a storage unit 112. These will be described below.

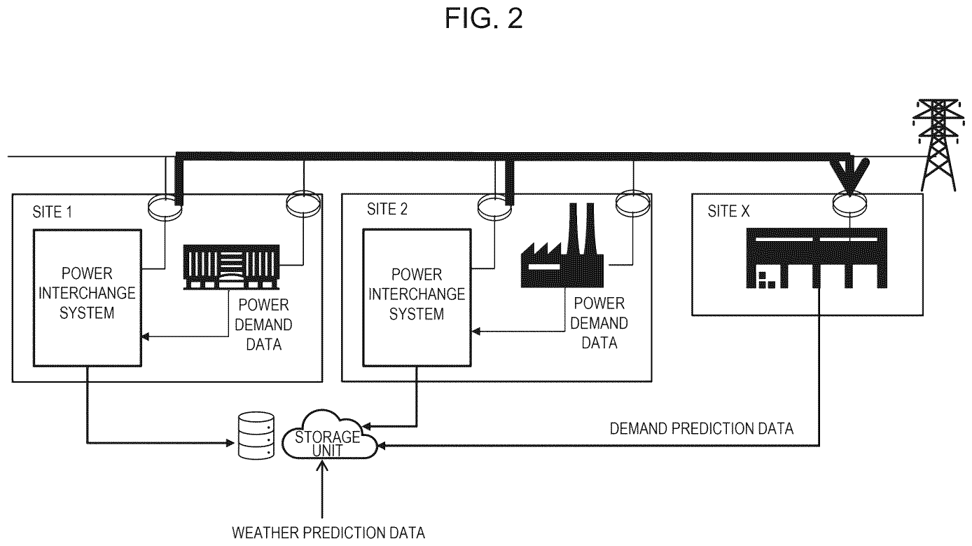

FIG. 2 is a schematic diagram showing a state in which the power interchange is performed between sites. A site 1 includes the power interchange system 1 described in FIG. 1, and a site 2 also includes similar facility. Power generated at the site 1 and the site 2 is transmitted to a site X via a power network. The power control device 11 controls transmitted power based on weather prediction data, demand prediction data, measurement data of each facility, or the like according to a procedure described later.

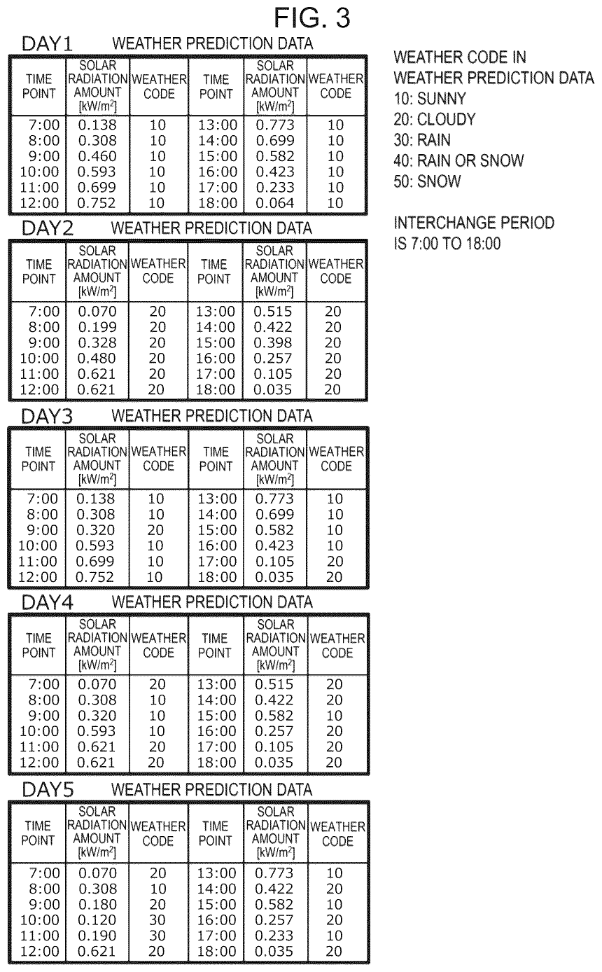

FIG. 3 shows an example of weather prediction data provided by a weather information provider. In the weather prediction data, a solar radiation amount per hour and weather codes provided by a major classification such as 10 to 50 are described. For example, sunny is classified as 10, cloudy is classified as 20, and rainy is classified as 30. In the invention, a type of the weather code in a power interchange period (period in which power is interchanged between sites: 7:00 to 18:00) is counted, and a weather pattern is determined based on the counted value. The weather pattern will be described below. For example, the weather code of DAY1 (a) is only 10 (sunny) in the power interchange period. Therefore, the count is one type. For DAY3 (c), 10 (sunny) or 20 (cloudy) is mixed in the power interchange period. In this case, the count is two types. Finally, in DAY 5 (e), since the weather codes of 10 (sunny), 20 (cloudy), and 30 (rainy) are mixed during the power interchange period, the count value is set to three types.

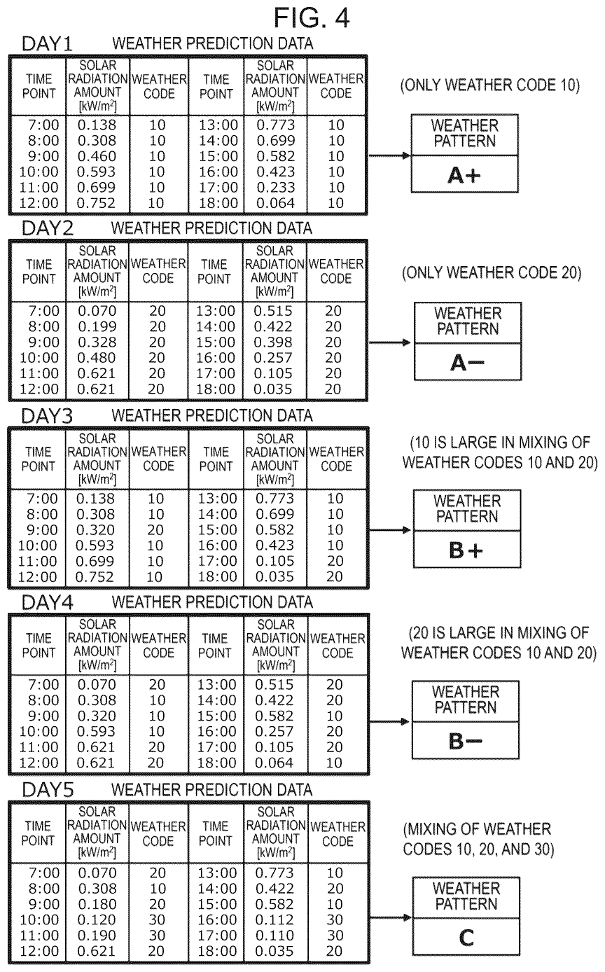

FIG. 4 shows an example of determining each weather pattern based on the weather codes in the weather prediction data of FIG. 3. Based on the count of the weather code determined in FIG. 3, weather patterns from DAY1 to DAY5 are determined. When the count in the power interchange period is one type and all weather codes are 10 (sunny) (DAY1), the weather pattern on the day is set to A+. DAY2 of which the count is one type and all weather codes are 20 (cloudy) is set to A−. When there are two types of counts and 10 (sunny) and 20 (cloudy) are mixed (DAY3 and DAY4), the weather pattern is determined according to a larger ratio of 10 or 20 in the power interchange period. For example, since the ratio of 10 (sunny) is larger on DAY3, the weather pattern is set to B+, and since the ratio of 20 (cloudy) is larger on DAY4, the weather pattern is set to B−. Finally, since the count is three types and 30 (rainy) is included, DAY5 is set to a weather pattern C. When at least one of weather codes of 30 (rain), 40 (rain or snow), and 50 (snow) is included, the power interchange is not performed on that day. Since the weather pattern including three or more types of weather codes always includes one of 30, 40, and 50, the power interchange is not performed.

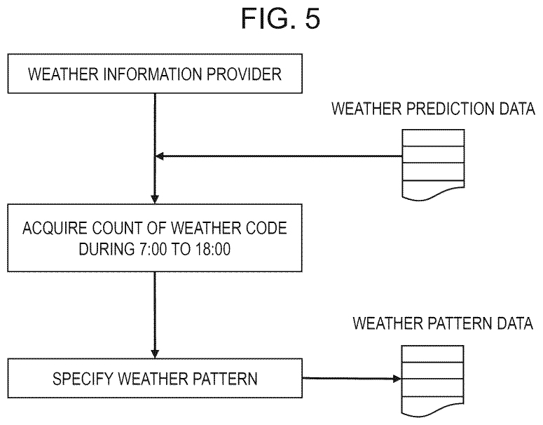

FIG. 5 is a flowchart showing a procedure in which the weather pattern is determined based on the weather code in the weather prediction data of FIG. 3. This flowchart is performed by the calculation unit 111. The calculation unit 111 acquires, from the weather information provider, weather prediction data in which a solar radiation amount and a weather code for each hour are described. The calculation unit 111 counts the weather code corresponding to the power interchange period among the acquired weather codes. If the count is one type and 10 (sunny), the weather pattern on the day is A+, and if 20 (cloudy), the weather pattern is A−. If there are two types of weather codes, B+or B− is determined according to a ratio between 10 (sunny) and 20 (cloudy). If there are three types of weather codes including 30 (rain), 40 (rain or snow), and 50 (snow), the weather pattern is C. An output result of the weather pattern is stored in a storage unit 112 as weather pattern data.

In the invention, attention is paid to weather patterns having a large variation width and a large number of times of variation and having a small variation width and a small number of times of variation in the solar radiation amount. As a procedure for comparing the variation width and the number of times of variation in the solar radiation amount with other weather patterns, for example, the following can be used. Solar radiation amount data provided from the weather information provider is described at each predetermined time point. When the variation width of the solar radiation amount between time points is equal to or larger than a threshold, one time of solar radiation amount variation is counted, the smallest count value among the weather patterns corresponds to the weather pattern A+ or A−, and the largest count value corresponds to the weather pattern B− (however, excluding the pattern C). Alternatively, instead of this, an alternative method may be used in which absolute values of differences in solar radiation amount between time points are added up over the entire interchange period. Further, since a solar radiation amount and generated power of a solar battery correspond to each other, a variation width and the number of times of variation of the generated power may be similarly measured using generated power history data of the solar battery for each time point instead of the solar radiation amount data.

In the invention, it is assumed that a power generation command value for the photo voltaic system 12 is obtained by multiplying an interchange plan by a predetermined coefficient (referred to as likelihood, ≤1.0) such that a power generation capacity of the photo voltaic system 12 has a certain margin. Therefore, an actual interchange plan power amount is interchange plan×likelihood. Hereinafter, the likelihood in the weather pattern A+ is referred to as a likelihood a, the likelihood in the weather pattern A− is referred to as a likelihood a′, and the likelihood in the weather pattern B− is referred to as a likelihood b′.

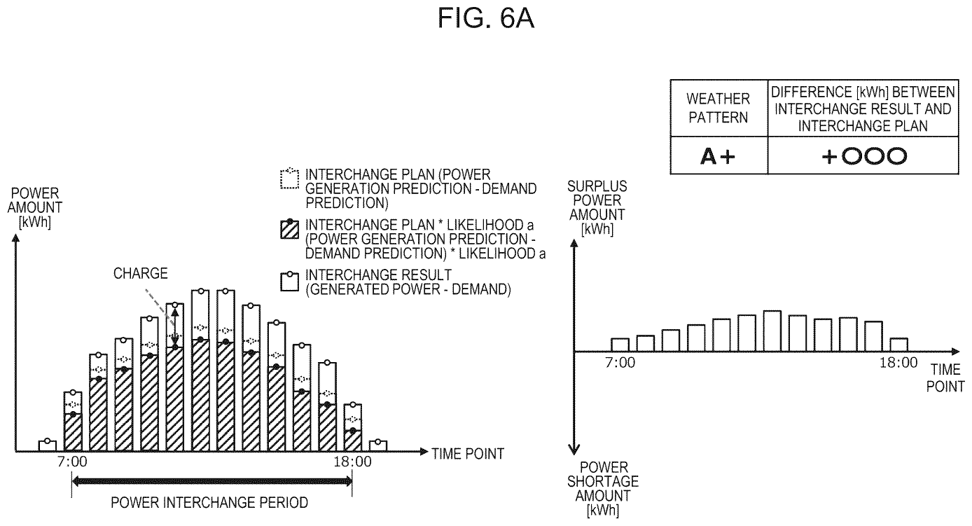

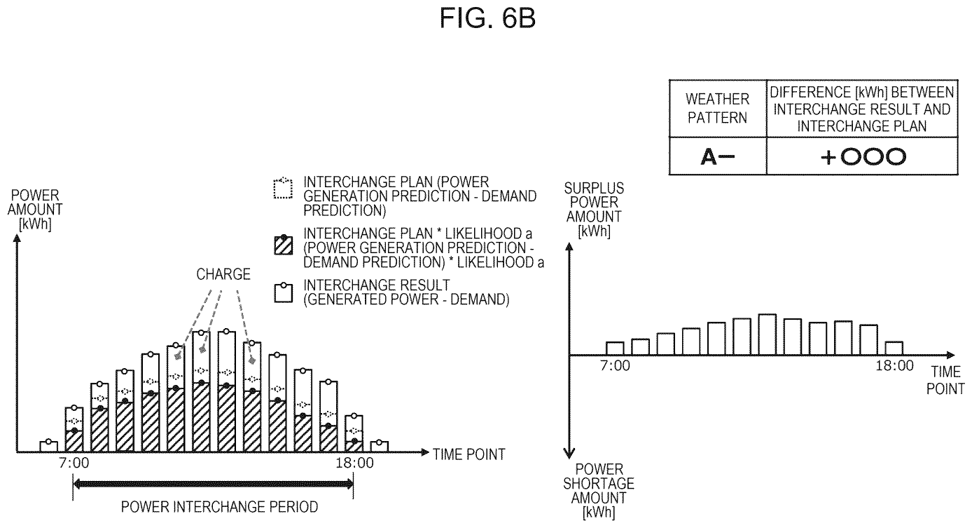

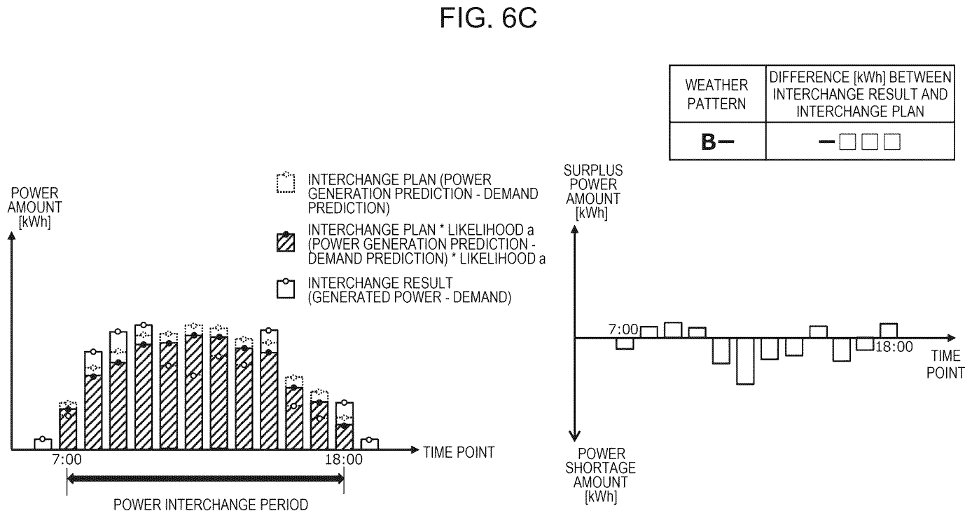

FIG. 6A is a graph for comparing an interchange result and an interchange plan in the weather pattern A+. When the weather pattern is A+, since all the weather codes in the power interchange period are 10 (sunny), the variation width and the number of times of variation in the solar radiation amount are small (substantially 0). Accordingly, the interchange result does not greatly vary, and the interchange result gradually increases until a time period in which the solar radiation amount in the daytime reaches a peak and then gradually decreases. Therefore, a difference between the interchange plan and the interchange result does not vary greatly. In the case of the weather pattern A+, the difference between the interchange result and the interchange plan is always positive (interchange result-interchange plan>0). That is, a surplus power amount is always generated during the power interchange period. During the power interchange period, the power control device 11 instructs the storage battery system 13 to perform a charge operation so as to allocate the surplus power amount to charging. That is, when the difference between the interchange result and the interchange plan in the weather pattern A+ is always positive, during the power interchange period, the power is interchanged to the other sites while charging a storage battery with the surplus power amount in preparation for a power shortage amount on the next day.

FIG. 6B is a graph for comparing an interchange result and an interchange plan in the weather pattern A−. In the weather pattern A−, since all the weather codes in the power interchange period are 20 (cloudy), similarly to the weather pattern A+, there is almost no variation width and the number of times of variation in the solar radiation amount, and there is no large variation in the interchange result. In addition, a difference between the interchange result and the interchange plan is always positive (interchange result-interchange plan>0), and a surplus power amount is generated. Therefore, the power control device 11 instructs the storage battery system 13 to perform a charge operation so as to allocate the surplus power amount to charging. In the case of the weather pattern A−, in preparation for a power shortage amount on the next day, a charged power amount equivalent to that of the weather pattern A+ is also secured in the storage battery. In the weather pattern A−, since the interchange result relatively decreases with respect to the weather pattern A+, a power amount to be interchanged decreases.

FIG. 6C is a graph for comparing an interchange result and an interchange plan in the weather pattern B−. Compared to the weather patterns A+ and A−, the weather pattern B− has a large variation width and a large number of times of variation in the solar radiation amount, and thus the interchange result also varies greatly and frequently. Therefore, a difference between the interchange result and the interchange plan greatly varies in the power interchange period. When the difference between the interchange result and the interchange plan is positive, a charge command is sent from the power control device 11 to the storage battery system 13, and when the difference is negative, a discharge command is sent to the storage battery system 13 to interchange power while compensating for the power shortage amount. In particular, the weather pattern B− has large variation in the interchange result and has an extremely large time period in which the power shortage amount is generated.

In the invention, for a site of the weather pattern B− at which variation in a power generation result is large and the power shortage amount is large, a shortage of the power amount to be interchanged to the other site (the site X in FIG. 2) is compensated from a surplus power amount at a site of the weather pattern A+ (or A−). This is because the site of the weather pattern A+ (or A−) has small variation in the power generation result, and a surplus power amount is generated. By this compensation, even when the site of B− itself cannot satisfy a predetermined interchange plan at the site of B−, the interchange plan at the site of B− can be observed by compensation from the site of A+ (or A−). The combination of the sites of A+ (or A−) used for compensation is searched when the site of B-is generated. The difference between the interchange result and the interchange plan can be associated with the weather pattern on a one-to-one basis (the reason will be described later). Therefore, a site used for compensation can be searched by referring to the weather pattern at each site.

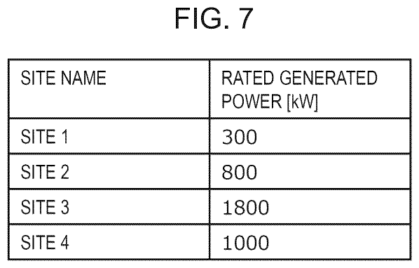

FIG. 7 shows an example of data of rated generated power of photo voltaic for each site. The calculation unit 111 acquires rated generated power information of the photo voltaic system 12 in order to determine the difference between the interchange result and the interchange plan at each site in detail. The difference between the interchange result and the interchange plan is proportional to a magnitude of the rated generated power of the photo voltaic system 12. Therefore, by acquiring the rated generated power information of the photo voltaic system 12 after the weather pattern is determined by the calculation unit 111, it is possible to correctly determine the difference between the interchange result and the interchange plan at each site and combine the sites at which the compensation is performed. The significance of determining the difference will be described later.

The rated generated power of the photo voltaic system 12 can also be used as a weighting of a combination of the sites at which the compensation is performed. In other words, the rated generated power of the photo voltaic system 12 at the sites of the weather pattern A+ and the weather pattern A− can be compared, and a site having a larger surplus power amount can be selected and determined as the combination.

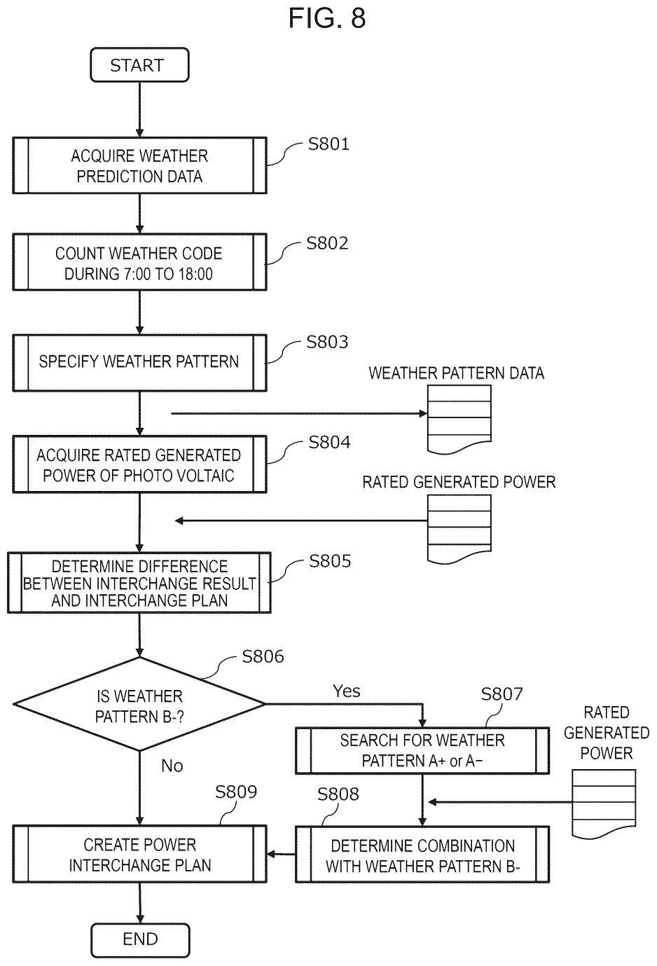

FIG. 8 is a flowchart showing a procedure in which the power control device 11 determines a combination of power interchange sites according to a weather pattern. This flowchart can be performed for each site at which power is interchanged. Hereinafter, each step in FIG. 8 will be described.

### FIG. 8: Steps S801 to S803

The calculation unit 111 acquires, from the weather information provider, weather prediction data in which a solar radiation amount and a weather code for each hour are described (S801). The calculation unit 111 counts (described with reference to FIG. 3) types of weather codes corresponding to a power interchange period (7:00 to 18:00) among the acquired weather codes (S802). The calculation unit 111 specifies a weather pattern based on a count value (S803). An output result of the weather pattern is stored in the storage unit 112 as weather pattern data.

### FIG. 8: Steps S804 to S806

The calculation unit 111 acquires the rated generated power of the photo voltaic system 12 from the storage unit 112 (S804). The calculation unit 111 determines a difference between an interchange result and an interchange plan based on the weather pattern specified by the count value and the rated generated power of the photo voltaic system 12 (S805). When a weather pattern at a site that is a target of the flowchart is B−, the processing advances to S807. Otherwise, the processing advances to S809 (step S806).

### FIG. 8: Step S805: Supplement

S805 is significant as a preparation for searching for power transmission source sites of the weather patterns A+ and A− in S807. Therefore, the difference between the interchange result and the interchange plan may be recognized with such accuracy that these sites can be specified. Therefore, in S805, data (example: FIG. 7) describing the rated generated power of each site is acquired, and further, it is estimated how much the rated generated power is exhibited according to the weather pattern at each site. Accordingly, the difference between the interchange result and the interchange plan is simply acquired (determined). For example, by multiplying the rated generated power by a coefficient (a numerical value gradually decreasing from A+ to C−) for each weather pattern, it is possible to estimate how much the rated generated power is exhibited for each weather pattern. Power actually transmitted by a power transmission source site may be calculated when a specific power transmission plan (power interchange plan) is created in S809.

### FIG. 8: Steps S807 to S808

The calculation unit 111 searches for a site of the weather pattern A+ (or A−) among other sites to which the power is interchanged (S807). For example, a weather pattern of each district at which a site is disposed may be acquired from the weather pattern data. The calculation unit 111 determines a combination of the searched site and the site that is the target of the flowchart (S808). At this time, a weight of a power amount compensated from the searched site can also be determined based on the rated generated power of the photo voltaic system 12.

### FIG. 8: Steps S807 to S808: Supplement 1

Based on the site of the weather pattern A+ or A− and the rated generated power at the site, the calculation unit 111 searches for these sites, for example, in descending order of the surplus power generation amount. When a shortage of an interchange power amount at the site of the weather pattern B− (a power amount transmitted from the site of B− to a power transmission destination site) can be compensated by only one site obtained by the search, a combination of the site and the site of B− is determined. When two or more sites are required for compensation, the power amounts transmitted by the two or more sites are weighted and then determined. For example, a surplus power amount may be simply calculated based on a weather pattern and rated generated power, and a ratio of the surplus power amount may be used as a weight. Alternatively, a ratio of the rated generated power at each site may be simply used as a weight. A load ratio for compensation may be determined by other appropriate weighting.

### FIG. 8: Steps S807 to S808: Supplement 2

The calculation unit 111 may acquire a history of past interchange results at each site and perform S807 based on the history. For example, among the sites of the weather pattern A+ or A−, these sites may be searched in descending order of a cumulative value or an instantaneous value of a power amount interchanged to other sites in the past.

### FIG. 8: Step S809

Based on the results of the above steps, the calculation unit 111 creates a power interchange plan at the site that is the target of the flowchart.

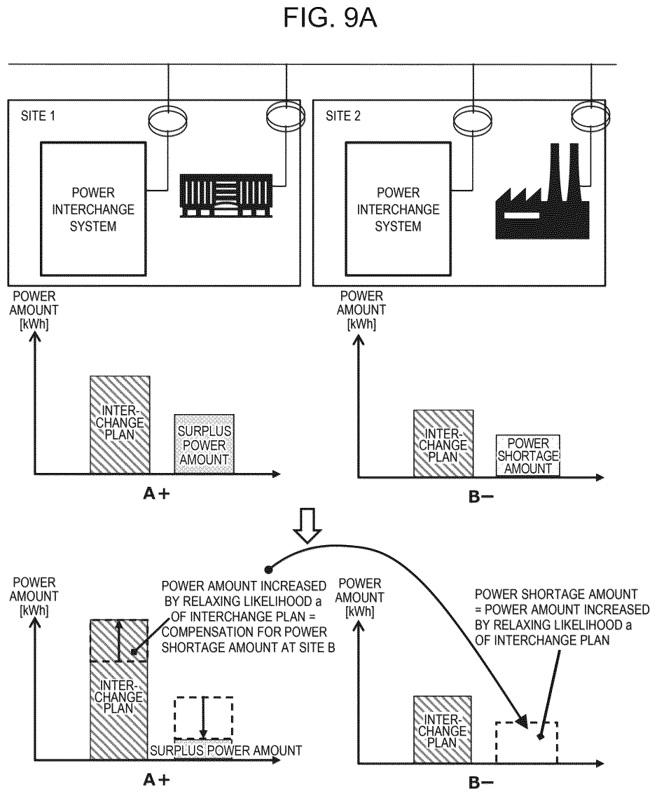

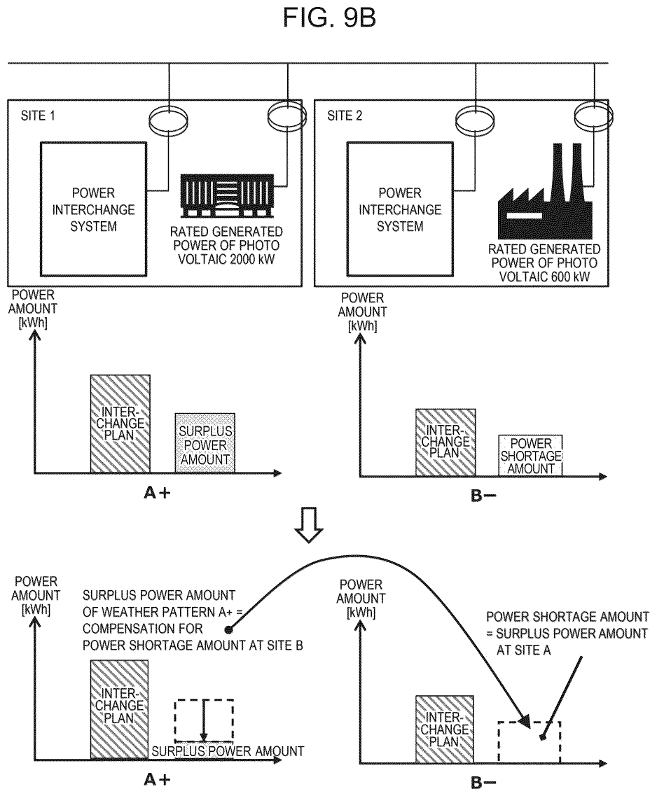

FIGS. 9A and 9B are diagrams showing a power interchange method for compensating for a power shortage amount from a plurality of sites. The site 1 has the weather pattern A+, and the site 2 has the weather pattern B−. Each of the sites 1 and 2 includes the power interchange system 1 shown in FIG. 1. The sites 1 and 2 have a plan to interchange power to another site (the site X in the example of FIG. 2).

A middle part of FIGS. 9A and 9B shows the interchange plan and the surplus power amount or the power shortage amount at each site (each weather pattern). Since the site 1 (weather pattern A+) has almost no variation width and the number of times of variation in the solar radiation amount in an interchange period, the storage battery system 13 is charged with the surplus power amount. In the site 2 (weather pattern B−), since the variation width and the number of times of variation in the solar radiation amount are large in the interchange period, even when the interchange plan is multiplied by the likelihood, a time period in which the interchange result is short for the interchange plan is generated, and as a result, a large amount of power shortage amount is generated. As a method for compensating for the power shortage amount generated in the site 2, two methods are conceivable, one described in FIG. 9A and the other described in FIG. 9B.

In the method of FIG. 9A, the power control device 11 sends a command to the photo voltaic system 12 to relax a likelihood a scheduled in the weather pattern A+ (bring a value of a close to 1.0). As the likelihood a is relaxed, the power amount transmitted from the site 1 increases (the surplus power amount decreases accordingly). In other words, the power amount generated by the relaxation of the likelihood can be allocated to a power amount for compensating for a shortage of an interchange power at a site at which the power amount is short. Therefore, the power shortage amount at the site 2 is compensated using the power amount generated by the likelihood relaxation of the site 1. As a result, the site 2 can compensate for the power shortage amount by using the power amount increased with the likelihood relaxation of the site 1 while keeping the interchange plan constant without limiting the interchange plan.

In the method of FIG. 9B, instead of changing the likelihood a, the surplus power amount of the weather pattern A+ is allocated to the compensation for the power shortage amount at the site 2. A power amount scheduled to be charged at the site 1 is used to compensate for the power shortage amount at the site 2 while the interchange plan for the site 1 and the site 2 is kept constant without being limited. As a result, it is possible to eliminate the power shortage amount at the site 2 while keeping the power amount to be interchanged to other systems. When the rated generated power of the photo voltaic at the site A is small and the power shortage amount at the site 2 cannot be compensated, the site having the weather pattern A+ or A− may be combined to compensate the power shortage amount. The same applies to FIG. 9A.

### Embodiment 1: Summary

The power interchange system 1 according to Embodiment 1 compensates the power amount that is short for power interchange from the site of the weather pattern in which the variation in the power generation amount is small to the power transmission destination site with respect to the site of the weather pattern in which the variation in the power generation amount is large. Accordingly, limiting for the interchange plan, which is a problem when power is interchanged at one site in the related art, becomes unnecessary by combining the plurality of sites. Therefore, it is possible to perform power interchange using the power generation amount generated by the photo voltaic system 12 as much as possible without limiting the interchange plan. In particular, a large penalty due to insufficient imbalance can be limited.

Since the power interchange system 1 according to Embodiment 1 compensates for the power shortage amount by combining the plurality of sites, the power amount compensated by discharging from the storage battery system 13 decreases, and the number of times of discharge (or a discharge amount) also decreases accordingly. Therefore, a stress on the storage battery system 13 is also alleviated.

### Embodiment 2

The power control device 11 described in Embodiment 1 can include the calculation unit 111 that performs the operations described in FIGS. 4 to 9B. The calculation unit 111 can be implemented by using hardware such as a circuit device in which the function is implemented, or can be implemented by a calculation device executing software in which the function is implemented. The power control device can further include a storage unit that stores a history of each piece of data (for example, power generation amount prediction data, demand data, demand prediction data, or the like) described in Embodiment 1.

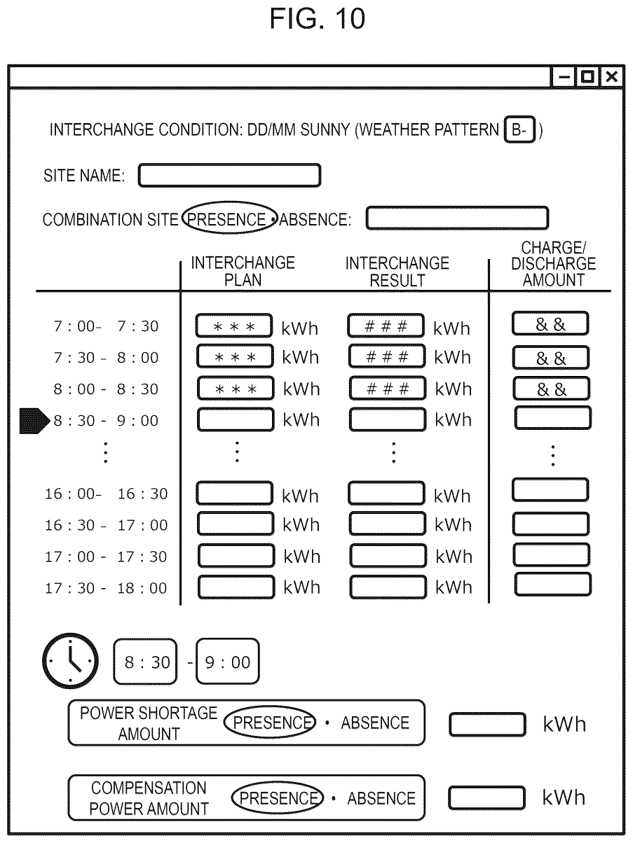

FIG. 10 is an example of a user interface provided by the power control device 11. The calculation unit 111 can present the user interface on a display device such as a display. The user interface can display, for example, a power amount to be output by the power interchange system and a charge or discharge amount of the storage battery at a start time point and an end time point during a consignment period for each weather code. Further, it is possible to display a power shortage amount, a compensation power amount, and a combination site name in each interchange period.

### Modifications of Invention

The invention is not limited to the above-described embodiments and includes various modifications. For example, the above-described embodiments have been described in detail to facilitate understanding of the invention, and the invention is not necessarily limited to those including all the configurations described above. In addition, a part of a configuration according to a certain embodiment can be replaced with a configuration according to another embodiment, and a configuration according to another embodiment can be added to a configuration according to a certain embodiment. In addition, another configuration can be added to a part of a configuration of each embodiment, and the part of the configuration of each embodiment can be deleted or replaced with another configuration.

In the above embodiments, it has been described that a transmitted power is compensated from a power transmission source site whose weather pattern is A+ or A− to a power transmission source site whose weather pattern is B−. A compensation source is not limited to this, and when the surplus power amount is sufficient, the compensation can be performed from the power transmission source site of the weather pattern B+.

In the above embodiments, as the difference between the interchange result and the interchange plan, a ratio between the two may be used instead of the difference itself. When the ratio is used, a surplus power amount is generated when the interchange result/interchange plan is larger than 1, and a power shortage amount is generated when the interchange result/interchange plan is smaller than 1. However, the difference and the ratio represent substantially the same content.

In the above embodiments, although the procedure in which the power control device 11 determines the combination of sites and the interchange power amount in the power interchange period and determines the power interchange has been described, the storage battery system 13 may be controlled by instructing the determined interchange power amount to the storage battery, or the power generation amount of the photo voltaic system 12 may be controlled using the determined combination of sites. The control can be performed, for example, via a command to a storage battery or a driving device (for example, a converter) that drives photo voltaic.

### REFERENCE SIGNS LIST

1: power interchange system
11: power control device
111: calculation unit
112: storage unit
12: photo voltaic system
13: storage battery system

1. A power interchange system that transmits a power amount between sites via a power transmission network, the power interchange system comprising:
a power generation system configured to generate power by a solar battery; and
a power control device configured to control a power transmission amount when a power generation amount generated by the power generation system is transmitted to a power transmission destination site via the power transmission network, wherein
the power control device includes a calculation unit that calculates the power transmission amount,
the calculation unit determines a weather variation pattern in a power transmission period, in which the power transmission amount is transmitted to the power transmission destination site, based on a value of a weather code describing a result of predicting a weather type in the power transmission period,
the calculation unit determines the weather variation pattern at a power transmission source site where the power generation system is disposed is a first pattern or a second pattern, in the first pattern, the number of times that a variation width of the power transmission amount in the power transmission period is equal to or larger than a threshold being the largest among combination patterns represented by a combination of the weather codes at each time point, and in the second pattern, the number of times that the variation width of the power transmission amount in the power transmission period is equal to or larger than the threshold being smaller than the number of times in the first pattern among the combination patterns,
when the weather variation pattern in any of a plurality of power transmission source sites is the first pattern, the calculation unit searches the plurality of power transmission source sites for one or more power transmission source sites in which the weather variation pattern is the second pattern, and
the calculation unit controls the power transmission amount to compensate for a shortage of the power transmission amount that is short in the power transmission source site in which the weather variation pattern is the first pattern with a surplus power generation amount generated in the searched power transmission source site.

2. The power interchange system according to claim 1, wherein
the weather code includes a code representing sunny and a code representing cloudy,
the calculation unit determines whether the weather variation pattern corresponds to either the first pattern or the second pattern based on the number of codes representing sunny and the number of codes representing cloudy among the weather codes at each time point,
the first pattern is formed by the combination pattern in which the weather codes at each time point in the power transmission period are formed by only sunny and cloudy and the number of cloudy is larger than the number of sunny, and
the second pattern is formed by the combination pattern in which the weather codes at each time point in the power transmission period are formed by only sunny or only cloudy.

3. The power interchange system according to claim 1, wherein
the weather code includes a code representing at least one of rain or snow, and
when the weather code describes a code representing at least one of rain or snow, the calculation unit controls the power transmission amount so as not to transmit the power generation amount to the power transmission destination site.

4. The power interchange system according to claim 1, wherein
the calculation unit acquires a plan power amount planned as the power transmission amount in the power transmission period,
the calculation unit acquires an actual power amount actually output to the power transmission network as the power transmission amount in the power transmission period,
the calculation unit calculates a difference between the actual power amount and a corrected plan power amount obtained by applying a correction coefficient to the plan power amount, and
the calculation unit controls the power transmission amount based on the difference.

5. The power interchange system according to claim 4, wherein
the correction coefficient is a coefficient for causing the power generation system to have an available operation capacity such that the power generation system outputs the power generation amount smaller than a power generation capacity of the power generation system,
the calculation unit searches the power transmission source sites for a surplus power site having the surplus power generation amount even when the power transmission amount is transmitted, and
the calculation unit changes the correction coefficient such that the corrected plan power amount increases to allocate at least a part of the corrected plan power amount to compensate for the shortage in the searched surplus power site.

6. The power interchange system according to claim 1, wherein
the calculation unit searches the power transmission source sites for a surplus power site having the surplus power generation amount even when the power transmission amount is transmitted, and
the calculation unit allocates at least a part of the surplus power generation amount to compensate for the shortage in the searched surplus power site.

7. The power interchange system according to claim 1, wherein
the calculation unit acquires a history of a power amount transmitted to another site in past in the power transmission source site where the weather variation pattern is the second pattern, and
the calculation unit performs the search by specifying the power transmission source site in descending order of the power amount transmitted in the past according to the history.

8. The power interchange system according to claim 1, further comprising:
a storage battery system, wherein
when a power amount generated by the power generation system is less than the power transmission amount transmitted from the power transmission source site to the power transmission destination site and the compensation is not performed, the calculation unit compensates for the shortage of the power transmission amount by causing the storage battery system to discharge, and
the calculation unit performs the compensation to reduce at least one of the number of times of discharging of the storage battery system or a discharge amount as compared with a case where the compensation is not performed.

9. The power interchange system according to claim 4, wherein
the calculation unit calculates the plan power amount based on a predicted power generation amount of the solar battery in the power transmission period and power demand prediction in the power transmission period.

10. The power interchange system according to claim 1, wherein
the calculation unit outputs a user interface, and
the user interface presents the shortage in the power transmission source site, and presents, when the shortage is compensated for, the compensation.
